(19) United States
(12) Patent Application Publication
(10) Pub. No.: US 2007/0106530 A1
(43) Pub. Date: May 10, 2007

(54) Oscillation suppression

(76) Inventors: Peter John Blamey, Victoria (AU); Benjamin John Smith, Victoria (AU); Brenton Robert Steele, Victoria (AU)

Correspondence Address: KNOBLE, YOSHIDA & DUNLEAVY, EIGHT PENN CENTER, SUITE 1350, 1628 JOHN F KENNEDY BLVD, PHILADELPHIA, PA, 19103, US

(21) Appl. No.: 10/557,534

(22) PCT Filed: May 26, 2004
(86) PCT No.: PCT/AU04/00702

§ 371 Date: Jul. 24, 2006

(51) Int. Cl. G06Q 10/00

(52) U.S. Cl. 705/2

(57) ABSTRACT

The invention relates to oscillation suppression and, more particularly, concerns a method and apparatus for suppressing oscillation in a signal identified as or suspected of containing an oscillation due to feedback. The method involves converting the signal into frequency bands in the frequency domain, applying, for a selected period of time, a randomly changing phase to the signal in at least one of said frequency bands, and reconverting the converted signal into an output wave form signal. The selected period is divided into a series of successive time windows, and for each successive time window a newly generated random or pseudo-random phase is applied to the signal. The method can be used in combination with a method for detecting oscillation in said signal in each of the frequency bands, a randomly changing phase applied in each frequency band for which said oscillation has been detected. The invention has particular application in hearing aid devices.

### FIELD OF THE INVENTION

The present invention relates to oscillation suppression and, more particularly, concerns a method and apparatus for suppressing oscillation in a signal identified as or suspected of containing an oscillation due to feedback. The present invention may be used in conjunction with a suitable approach to identifying such oscillation, such as the method and apparatus for identifying oscillation in a signal due to feedback described in applicant's co-pending international application entitled ‘Oscillation Detection’, based on Australian provisional patent application AU-2003902588.

### BACKGROUND OF THE INVENTION

In this specification, where a document, act or item of knowledge is referred to or discussed, this reference or discussion is not an admission that the document, act or item of knowledge or any combination thereof was, at the priority date, part of common general knowledge, or known to be relevant to an attempt to solve any problem with which this specification is concerned.

Acoustic amplifiers are used in many common applications such as telephones, radios, headsets, hearing aids, and public address systems. Typically, such an application comprises a microphone or other input transducer to pick up sounds and convert them into an electrical signal, an electronic amplifier to increase the power of the electrical signal, and a speaker or other output transducer to convert the amplified electrical signal back into sound.

If the input and output transducers are close enough, the output acoustic signal may be picked up by the input transducer and fed back into the amplifier with a delay, the delay being the time taken for the sound to travel from the output transducer to the input transducer (plus any delay due to the electrical processing of the signal). This is ‘acoustic feedback’. Electrical feedback can also occur if the electrical signal at the output is coupled back to the input, for example by inductive or capacitive coupling. Further, mechanical feedback can also occur if vibrations are transmitted from the output transducer to the input transducer via the body or case of the amplification system. Under feedback conditions, the device can then become unstable and the components begin to ring. The ringing then self-reinforces and increases in intensity to drive the components into saturation. FIG. 1 illustrates a feedback loop, showing diagrammatically the components in an acoustic amplifier circuit, namely microphone 1, amplifier 2 and speaker 3, with feedback loop 4 representing the output signal feeding back to the input transducer.

All forms of feedback may result in instability or oscillation of the output signal from the amplifier under certain conditions. Oscillation and instability are undesirable because they distort the signals being amplified and can result in very loud unpleasant sounds. In the case of hearing aids, this can lead to problems both for the wearer and for those around. The conditions for oscillation are that the total gain around the loop must be greater than 1, so that the signal is fed back into the system with a greater intensity each time, and the total delay around the loop must be a whole number of periods of the oscillation frequency, so that the input and output signals add constructively. Equivalently, the total phase change around the loop must be a multiple of 2π radians for the oscillation frequency. These criteria are set out in equations 1 to 3 below.
Loop Gain>1 (eq. 1)
Loop Delay=N×period (eq. 2)
Loop Phase Change=2 Nπ radians (eq. 3)
(where N is a positive integer)

Any electronic system containing a microphone and speaker in dose proximity may suffer from acoustic feedback. In hearing aids, this often results in the wearer experiencing unpleasant audible effects such as loud whistling tones at certain frequencies, usually high frequencies.

The traditional procedure for increasing the stability of a hearing aid is to reduce the gain at high frequencies, as suggested in, for example, U.S. Pat. No. 4,689,818. This may be done by setting the maximum gain value for each frequency, or automatic high frequency (HF) gain roll-off may be used. Controlling feedback by modifying the system frequency response, however, means that the desired high-frequency response of the instrument must be sacrificed in order to maintain stability.

Efforts have been undertaken to reduce the susceptibility of hearing aids to feedback oscillation by improving the fit and insulating properties of the ear mould. Efforts have also been undertaken from an electrical standpoint, from attenuation and notch filtering, as disclosed in U.S. Pat. No. 4,088,835, to estimation and subtraction of the feedback signal, as disclosed in U.S. Pat. No. 5,016,280, to frequency shifting or delaying the signal, as disclosed in U.S. Pat. No. 5,091,952. Many different approaches to an electrical solution with continuous monitoring of the feedback path have been documented in the relevant literature.

A technique commonly used to suppress feedback in public address systems is a frequency shift, in which the input signal is altered by a few Hertz prior to being output at the receiver. This approach has not been particularly successful in hearing aids because a large frequency shift is required to achieve a significant increase in gain. In hearing aids, the distance between microphone and receiver is much smaller than in public address systems, and thus a feedback signal with only a small frequency shift may still be relatively closely in phase with the input.

Signal phase can also be altered by using a time-varying delay [1]. While this can provide 1-2 dB of additional useable gain, it can also result in an audible ‘warbling’ effect. AR pass filters have also been used to modify the phase response of the feedback loop, but it can be difficult to achieve satisfactory phase at all frequencies. Methods have been proposed to push danger regions in the phase response to frequencies outside the primary audio range where'suppression can be applied without loss of sound quality [2] [3]. These techniques still assume that the feedback path is constant however, and no suggestion has been made that an adaptive implementation may be developed.

The most common gain altering approaches attempt to reduce the system gain only in narrow bands where feedback is likely to occur. This has been attempted with a variety of notch filter implementations [1] [4] [5]. Adaptive notch filtering has allowed 3-5 dB of additional useable gain. Two of the biggest problems with notch filtering techniques have been the inability to accurately track the variations in the feedback path with a narrow band, and the effects on normal spectral content with a broader band. In addition, the notch filter can actually contribute an additional phase change to the loop and shift the frequency of oscillation as soon as it is applied.

Substantial increases in useable gain have been achieved by inserting an additional feedback path, based on an estimation of the real feedback path, but 180 degrees out of phase. Early adaptive implementations of such systems performed continuous estimation of the feedback path by inserting noise signals with appropriate statistical properties at the receiver and correlating the output with the input at the microphone [1] [6]. These reported up to 10 dB of additional useable gain [7] but, since the noise ‘test’ signals were audible and unpleasant for most wearers, this particular technique never became particularly widespread.

More recent feedback cancellation systems of this type rely on sounds in the environment to perform their correlation [8]. To avoid artefacts and incorrect suppression of speech however, the estimation time has to be longer than in systems using unnatural sounds to perform correlation. This means that sudden changes in the feedback path can result in several seconds of whistling before successful cancellation occurs. If implemented in conjunction with another technique to handle sudden changes, this approach can allow at least 10 dB of additional useable gain [9]. The benefits and limitations of such systems are discussed in [10].

Nearly all of the techniques discussed here require some knowledge of the frequency of oscillation. However, as a result of the nature of direct and multiple reflected acoustical paths between microphone and speaker (or the changing acoustic properties of the ear/earmould/hearing aid coupling with regard to hearing aids) the frequency of acoustic feedback is unpredictable and may extend over a substantial portion of the audio frequency spectrum (between 20 and 20,000 Hz). As a result, it is desirable to have a circuit that can quickly identify an oscillation and its frequency.

U.S. Pat. Nos. 4,232,192 and 4,079,199 propose systems using a phase locked loop (PLL) adapted to recognize an oscillation when it occurs. As is known, however, when the input signal falls off, a PLL tends to become unstable and to drift. The result of the drift is an undesirable periodic, acoustic noise signal.

U.S. Pat. No. 4,845,757 describes another oscillation recognition circuit. This circuit detects oscillations by looking for long-lasting alternating voltages having relatively large amplitude and relatively high frequency. This is problematic in many applications because it means that the signal may contain feedback oscillations for some time before they are identified by such a circuit.

There remains a need in the art to provide an improved or at least an alternative way of detecting oscillations in a signal in a reliable, effective and rapid manner, and to apply appropriate suppression to the signal upon detection.

### SUMMARY OF THE INVENTION

The invention provides, in accordance with a first aspect, a method for suppressing oscillation in a signal identified as or suspected of containing an oscillation, the method comprising the following steps:
converting the signal into frequency bands in the frequency domain;
applying, for a selected period of time, a randomly changing phase to the signal in at least one of said frequency bands; and
reconverting the converted signal into an output waveform signal.

This method has the effect of disrupting the consistent constructive addition of the feedback signal to the input signal, providing a simple but very effective solution to the suppression problem.

Preferably, said selected period is divided into a series of successive time windows, and for each successive time window a newly generated random or pseudo-random phase is applied to the signal. This technique thus provides the randomly changing signal phase.

The method may be applied in combination with a method for detecting oscillation due to feedback in said signal in each of said frequency bands, a randomly changing phase applied in each frequency band for which said oscillation has been detected.

The oscillation detection technique may comprise calculating, for each frequency band, the change in signal phase and/or signal amplitude from a time window to a subsequent time window, and comparing, for some or all of said frequency bands, the results of the calculation step to defined criteria to provide a measure of whether oscillation due to feedback is present in the signal.

Alternatively, the oscillation detection technique may be a phase locked loop method, or may involve detection of a large sustained amplitude in a particular frequency band.

The randomly changing phase may be applied in each frequency band to a gain value to be applied to the signal.

In a preferred form, the method includes the step of, for a particular frequency band, generating a complex number with random or pseudo-random phase and amplitude 1.0 for each successive time window, and applying this complex number to the signal in that frequency band. A real gain value for said frequency band may be multiplied by said complex number before the gain is applied to the signal.

In an alternative form, the method may include the step of, for a particular frequency band and in each successive time window, replacing the signal or signal gain with a signal or signal gain having equal amplitude and a random or pseudo-random phase.

The invention provides, in accordance with a second aspect, an apparatus for suppressing oscillations in a signal identified as or suspected of containing an oscillation, comprising:
means for converting the signal into frequency bands in the frequency domain;
means for applying, for a selected period of time, a randomly changing phase to the signal in at least one of said frequency bands; and
means for reconverting the converted signal into an output waveform signal.

The apparatus preferably includes means for dividing the signal into a series of successive time windows, and means for applying to the signal, for each successive time window, a newly generated random or pseudo-random phase.

Preferably, the apparatus is provided in combination with a means for detecting oscillation due to feedback in said signal in each of said frequency bands, the means for applying arranged to apply a random phase in each frequency band for which said oscillation has been detected.

The means for detecting oscillation may comprise means for calculating, for each frequency band, the change in signal phase and/or signal amplitude from a time window to the next, and means for comparing, for some or all of said frequency bands, the results of the calculation step to defined criteria to provide a measure of whether oscillation due to feedback is present in the signal. Alternatively, the means for oscillation detection may comprise phase locked loop circuitry, or means for detection of a large sustained amplitude in a particular frequency band.

In a preferred form, the means for applying are arranged to apply the randomly changing phase in each frequency band to a gain value to be applied to the signal.

The apparatus may include means for generating a complex number with random or pseudo-random phase and amplitude 1.0 for each successive time window, and means for applying this complex number to the signal in that frequency band.

Preferably, means are included for multiplying a real gain value for said frequency band by said complex number before applying the gain to the signal.

In an alternative form, the apparatus includes means for, for a particular frequency band and in each successive time window, replacing the signal or signal gain with a signal or signal gain having a random or pseudo-random phase.

The invention provides alteration of the feedback loop in a manner that disrupts the feedback oscillation conditions and suppresses the oscillation without significantly affecting the system frequency response. If used with an appropriate oscillation detection technique, oscillation can be detected and suppressed very rapidly, and before audible ringing results.

The randomly changing phase is added in successive time windows over a certain length of time, for example approximately 8 seconds, to any frequency that appears to be in a state of oscillation. The length of time may be preselected, or may be dynamically determined with reference to the result of oscillation detection in that frequency band. The random phase variation suppresses the oscillation by disrupting the consistent constructive addition of the feedback signal to the input signal.

It should be noted that the feedback suppression method of the invention may be used with any suitable feedback detection approach. For example, the method may be used in a system which involves deriving gain values for the frequency bands in accordance with a specified signal processing algorithm. The derived gain may be compared (for some or all of said frequency bands) with a prescribed gain limit, in order to provide a measure as to whether oscillation due to feedback is present in the signal, and this to trigger the oscillation suppression.

### BRIEF DESCRIPTION OF THE DRAWINGS

The present invention will become more apparent by describing in detail a preferred non limiting embodiment with reference to the attached drawings, in which:

FIG. 1 is a block diagram schematically illustrating a feedback loop;

FIG. 2 is a block diagram of an apparatus according to the present invention;

FIG. 3 is a flow diagram illustrating the logic and process of feedback detection;

FIG. 4 is a flow diagram illustrating the logic and process of feedback suppression; and

FIGS. 5 and 6 are block diagrams of alternative architectures of apparatus according to the invention.

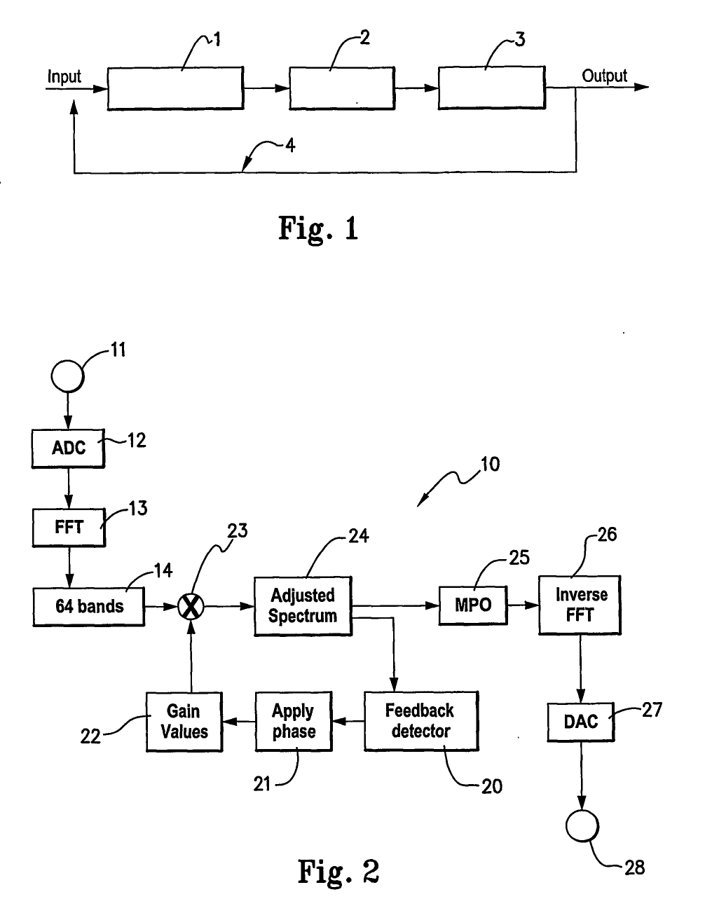

### DETAILED DESCRIPTION OF THE DRAWINGS

An acoustic system 10 in accordance with the invention, such as a hearing aid, is schematically depicted in FIG. 2. A microphone 11 converts an acoustic signal, such as the speech, into an analogue electrical signal proportional to the acoustic signal, which signal is then converted by an A/D converter 12 into a digital signal. The output of A/D converter 12 is connected to the input of a Discrete Fourier Transform (DFT) unit—such as a Fast Fourier Transform (FFT) unit 13—for analysing the frequency components of the signal, whilst unit 14 enables analysis of 64 frequency bands across the spectrum of the signal. A suitable unit is the Toccata Plus integrated circuit designed and developed by the Dspfactory, operating with 16 kHz sampling rate and using 128 point windows of 8 millisecond duration with 50% overlap to yield 64 linearly spaced frequency bands at 125 Hz intervals from 0 to 8000 Hz. Module 20 is a feedback detector arranged to monitor the phase and amplitude of the signal in each frequency band in the spectrum (adjusted if appropriate, as explained further below) during successive sampling windows at short intervals, such as successive 8 millisecond windows with 50% overlap, calculated every 4 milliseconds. The apparatus includes a counter for each frequency band, which can be incremented or reset at each successive time window.

For each time window, the measured phase from the previous window is subtracted from the phase in the current window to calculate the change in phase at a particular frequency band. This change in phase is compared to the previous change in phase. If the values are within a defined variation (ie the change in the phase change is within the threshold) then the counter is incremented, otherwise the counter is reset. Further, the amplitude in the current window is compared with the amplitude in the previous window. If the current amplitude is less than the previous amplitude, then the counter is reset. The feedback detector is programmed to respond—by triggering feedback suppression—to the counter reaching a value M. The present invention contemplates that either the change in phase change criterion (counter reaches Mₚ) or the change in amplitude criterion (counter reaches Mₐ may be considered for suppression triggering, or both.

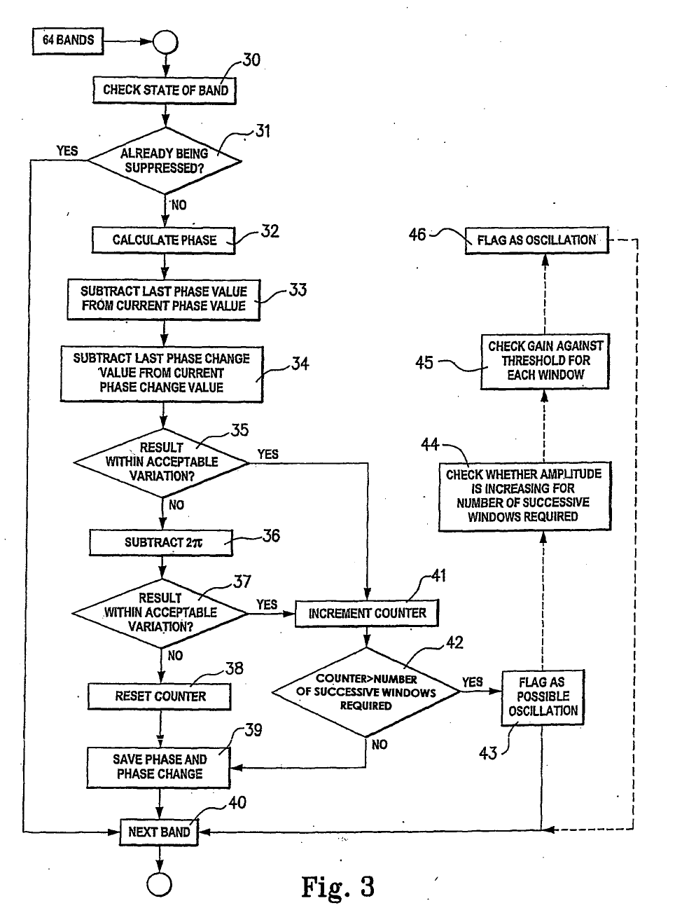

The example represented in FIG. 3 illustrates, for a time window, the process of detection using the change in phase change criterion. For each of the 64 bands, the state of the band is determined (30). If that band is already being suppressed (31); no calculations are performed. Otherwise, the phase is calculated (32), and the previous phase value calculated for that band (which value has been stored—see below) is subtracted from the current phase value (33) to provide a current value of phase change. The next step (34) is to subtract the previous phase change value from the current phase change value, to output a value of change of phase change. This value is then checked (35) and (37), and if it is within a certain prescribed threshold for phase change variation, the counter is incremented by 1 (41). The subtraction of 2π radians (36) and second check (37) ensure that output is dependent on the magnitude of the change of phase change, irrespective of whether the change has increased or decreased. If the value is not within the threshold, the counter is reset to 0 (38), the current phase and phase change value is saved (39), and the next band is selected (40).

The process described above, involving the step of subtracting 2π radians from the value of the change in phase change and re-checking whether the result is within the prescribed threshold (36, 37), can be replaced by an alternative technique. Instead, the full range of the signed fixed-point numbers can be used to represent the angular phase change from −π to +π, meaning that when successive phase change values are subtracted, the result is also in the range −π to +π. This is a standard calculation technique and will not be further described here.

If the counter has been incremented (41), a check is made to determine if it has reached a value Mₚ (42), thereby indicating an oscillation has been detected (43) and flagging that band for suppression (see below). If not, the current phase and phase change values are saved (39), and the next band is selected (40). It is to be noted that the bands can be checked in parallel or sequentially within each time window.

If the signal in each frequency band is also to be checked for increasing amplitude, the amplitude is monitored from one time window to the next and, if it is increasing over the prescribed number Mₐ of successive windows, this measure can be applied in determining whether an oscillation is present in the signal in that frequency band (reference 44 in FIG. 3).

In simulations carried out by the inventors, where both criteria for detection have been employed, Mₐ=Mₚ=12 gives good performance. Using Mₐ=Mₚ simplifies the detection apparatus and method, as the process can then readily be implemented using a common counter. If only one criterion is to be employed in detecting feedback, the Mₐ or Mₚ value may be increased to avoid false triggering of feedback suppression.

Once the counter for any frequency band exceeds the required values of Mₐ and/or Mₚ, this frequency band is deemed to be in oscillation, and an oscillation suppression algorithm is implemented (in this example, an ‘apply phase’ module 21 is triggered—see FIG. 2). Apply phase module 21 generates a complex number with random phase and amplitude 1.0 for each window, and multiplies the real gain value at module 22 for the frequency band by this complex number before the gain is applied to the signal via gain unit 23 to provide an adjusted spectrum 24. The loop illustrated in FIG. 2 indicates that the phase of the gain multipliers depends on the apply phase unit, which operates in accordance with the output of the feedback detector unit. Apply phase module 21 continues to apply random phase to the gain for a prescribed length of time (for example, around 8 s), to allow the conditions which created the feedback path to change.

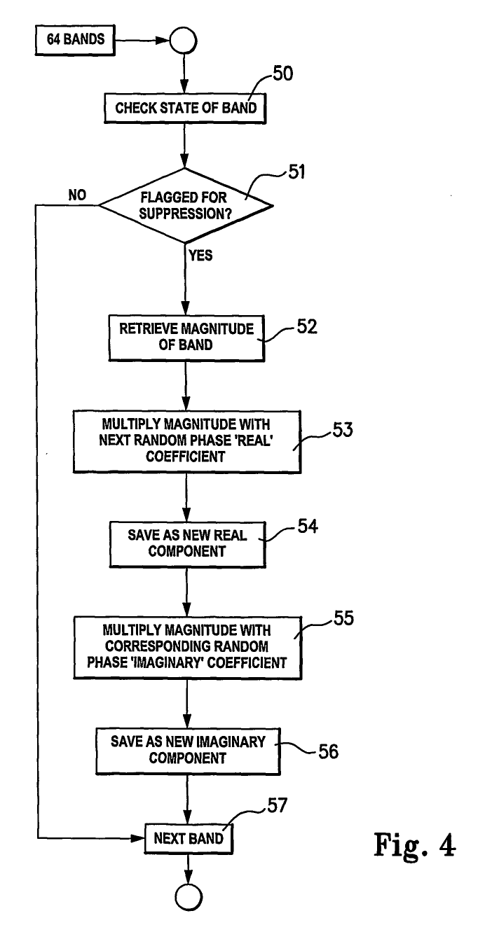

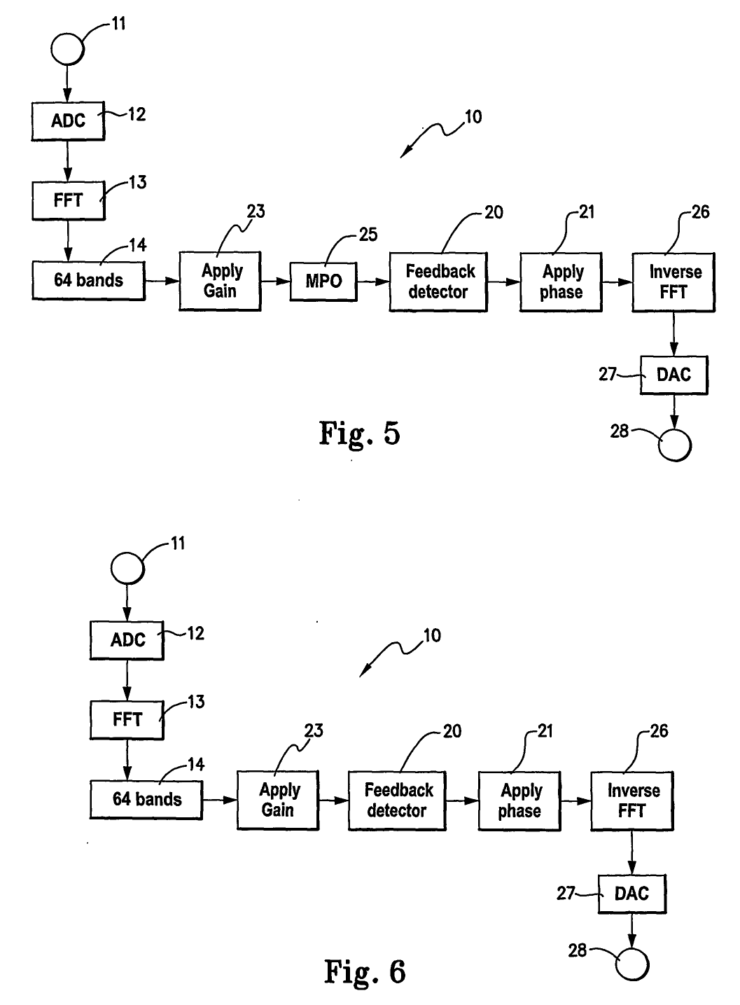

The example represented in FIG. 4 illustrates the process of suppression for a time window, appropriate for the example embodiments illustrated in FIGS. 5 and 6. Firstly, the state of a selected band is checked (50), to determine whether it is flagged for suppression (51). If not, the next band is selected (57). If it is flagged for suppression, the magnitude of the signal at that band is obtained (52) and multiplied by the real part of the generated random complex number (53), the resulting new real component being saved (54). Further, the magnitude of the signal is multiplied by the corresponding imaginary part of the generated random complex number (55), and the resulting new imaginary component saved (56).

The signal passes through MPO unit (Maximum Power Output) 25 (see FIG. 2), and is then reconverted into a time domain waveform by inverse FFT module 26. A D/A converter 27 then converts the digital signal to an electrical analogue signal before supplying it to the hearing aid output terminal to drive speaker 28.

It is to be noted that the ‘magnitude of the signal’ in a band referred to above in the context of FIG. 4 may be the output spectrum value (for the embodiments shown in FIGS. 5 and 6), or may be the gain value (for the embodiment shown in FIG. 2), and the invention may be implemented using either approach, the selection depending at least in part on the hardware employed for the processing. In the alternative architectures of FIGS. 5 and 6 the random phase is applied to the output spectrum rather than to the gains, in both embodiments the gain values are applied to the signal by gain unit 23 before feedback detector 20. In FIG. 6, MPO unit 25 is omitted, to illustrate that the invention can be implemented without such a component.

As will be evident to the skilled reader, it is not necessary to apply feedback detector 20 and oscillation suppression module 21 together. An alternative form of feedback detector, such as a phase locked loop (PLL) circuit, may be employed, apply phase module 21 being used to apply a random phase to the signal in that particular frequency band once-feedback has been detected.

It has been found in simulations carried out by the inventors that application of both feedback detector 20, combining the monitoring of both phase change and amplitude, along with the application of apply phase module 21, can result in suppression of all feedback oscillation in 60-100 milliseconds.

As the skilled reader will readily recognise, the method and apparatus of the present invention may be used in combination with other compatible signal processing techniques. For example, the present inventors have successfully incorporated an adaptive dynamic range optimisation (ADRO™) sound processor, of the sort described in International Patent Application WO-00/47014, into a system employing the feedback detection approach of the present invention.

In a system with adaptive gain (such as the ADRO™ processing strategy), feedback is more likely to occur when gains are high. In one form of the present invention, a further criterion is considered by the feedback detection algorithm, namely, for each of the 64 frequency bands, a comparison of the gain in each time window with a prescribed threshold level. This step is schematically illustrated by reference 45 in FIG. 3, as a factor in determining whether oscillation is present in the signal (46) in the relevant frequency band. In this approach, if both the signal phase criterion (described above) and the gain criterion are satisfied, then it is concluded that feedback is occurring, and feedback suppression is triggered.

This technique has the advantage that the risk of false triggering is reduced. In addition, as this method ensures that feedback will only be detected when gain values are relatively high, application of a gain reduction suppression technique to suppress the feedback will not reduce the gain to an undesirably low level.

In one implementation embodiment, when employed in combination with an adaptive gain system such as ADRO™, the gain threshold is defined as a fixed number of dB below the maximum limit placed on the gain by the adaptive gain system. This approach can also be taken in other nonlinear or adaptive systems that employ variable gain, such as in so-called ‘compression’ systems which apply lower gains to loud input signals and higher gains to softer input signals.

The present invention has been described above with reference to an implementation involving real-time feedback detection (eg in use by a hearing aid wearer), in order to trigger real-time suppression measures. However, as the skilled reader will appreciate, the oscillation detection technique described above can also be used for feedback management, applied at a setup (or adjustment) phase, in order to set parameters of the signal processing system. The feedback management step is therefore undertaken only once during the setup phase of the amplifying system, or during any subsequent resetting of the apparatus.

In this feedback management process, the feedback detection technique is used to detect the onset of feedback while amplifier gain limits are adjusted during the setup phase. This serves to remove steady state feedback, whilst the real-time feedback detection/suppression system then operates during normal use of the apparatus to reduce the occurrence of transitory feedback caused by changing environmental conditions.

Modifications and improvements to the invention will be readily apparent to those skilled in the art. Such modifications and improvements are intended to be within the scope of this invention. For example, in accordance with the invention, the signal spectrum may be split into a plurality of discrete frequency bands, or alternatively neighbouring bands may overlap.

The word ‘comprising’ and forms of the word ‘comprising’ as used in this description and in the claims does not limit the invention claimed to exclude any variants or additions.

### REFERENCES

[1] D K. Bustamante, T L. Worrall, and M J. Williamson, “Measurement and Adaptive Suppression of acoustic feedback in hearing aids,” in 1989 International Conference on Acoustics, Speech and Signal Processing, 1989.
[2] Rongtai Wang and Ramesh Harjani, “Acoustic Feedback Cancellation in Hearing Aids”, in Proceedings of the IEEE International Conference on Acoustics, Speech and Signal Processing, pp. 137-140, 1993.
[3] Rongtai Wang and Ramesh Harjani, “The Suppression of Acoustic Oscillation in Hearing Aids Using Minimum Phase Techniques”, in Proceedings of the IEEE International Symposium on Circuits and Systems, pp. 818-821, 1993.
[4] D. Egolf, “Acoustic feedback suppression in hearing aids,” tech. rep., VA Medical Center, 1984.
[5] D. Egolf, “Review of acoustic feedback literature from a control systems point of view,” in Amplification for hearing impaired: research needs, monographs in contemporary audiology, 1982.
[6] O. Dyrlund, N. Bisgaard, “Acoustical feedback margin improvements in hearing instruments using a prototype DFS system.” Scand Audiol. 1991; 20: pp 49-53.
[7] L. Henningsen, O. Dyrlund, N. Bisgaard, B. Brink “Digital Feedback Suppression” Scand. Audiol. 1994; 23: pp 117-122.
[8] J. Hellgren, T Lunner, S. Arlinger, “System identification of feedback in hearing aids,” in J Acoust. Soc. America 1999; 8: pp 333-336.
[9] F. Kuk, C. Ludvigsen, T. Kaulberg, “Understanding feedback and digital feedback cancellation strategies,” in The Hearing Review, February 2002; Volume 9, number 2: pp 36-49.
[10] F Kuk, C. Ludvigsen, “Understanding feedback and digital feedback cancellation strategies” in The Hearing Review, April 2002; Volume 9, Number 4.

1. A method for suppressing oscillation in a signal identified as or suspected of containing an oscillation, the method comprising:
converting the signal into frequency bands in the frequency domain;
applying, for a selected period of time, a randomly changing phase to the signal in at least one of said frequency bands; and
reconverting the converted signal into an output waveform signal.

2. The method of claim 1, wherein said selected period is divided into a series of successive time windows, and for each successive time window a newly generated random or pseudo-random phase is applied to the signal.

3. The method of claim 1, in combination with a method for detecting oscillation due to feedback in said signal in each of said frequency bands, a randomly changing phase applied in each frequency band for which said oscillation has been detected.

4. The method of claim 3, wherein the randomly changing phase is applied in each frequency band to a gain value to be applied to the signal.

5. The method of claim 3, in which the oscillation detection technique comprises calculating, for each frequency band, the change in signal phase and/or signal amplitude from a time window to a subsequent time window, and comparing, for some or all of said frequency bands, the results of the calculation step to defined criteria to provide a measure of whether oscillation due to feedback is present in the signal.

6. The method of claims 3, in which the oscillation detection technique is a phase locked loop method.

7. The method of claim 3, in which the oscillation detection technique includes detection of a large sustained amplitude in a particular frequency band.

8. The method of claim 2, including, for a particular frequency band, generating a complex number with random or pseudo-random phase and amplitude 1.0 for each successive time window, and applying this complex number to the signal in that frequency band.

9. The method of claim 8, in which a real gain value for said frequency band is multiplied by said complex number before the gain is applied to the signal.

10. The method of claim 2, including, for a particular frequency band and in each successive time window, replacing the signal or signal gain with a signal or signal gain having equal amplitude and a random or pseudo-random phase.

11. An apparatus for suppressing oscillations in a signal identified as or suspected of containing an oscillation, comprising:
means for converting the signal into frequency bands in the frequency domain;
means for applying, for a selected period of time, a randomly changing phase to the signal in at least one of said frequency bands; and
means for reconverting the converted signal into an output waveform signal.

12. The apparatus of claim 11, including means for dividing the signal into a series of successive time windows, and means for applying to the signal, for each successive time window, a newly generated random or pseudo-random phase.

13. The apparatus of claim 11, in combination with a means for detecting oscillation due to feedback in said signal in each of said frequency bands, the means for applying arranged to apply a random phase in each frequency band for which said oscillation has been detected.

14. The apparatus of claim 13, in which the means for detecting oscillation comprises means for calculating, for each frequency band, the change in signal phase and/or signal amplitude from a time window to the next, and means for comparing, for some or all of said frequency bands, the results of the calculation to defined criteria to provide a measure of whether oscillation due to feedback is present in the signal.

15. The apparatus of claims 11, wherein the means for applying are arranged to apply the randomly changing phase in each frequency band to a gain value to be applied to the signal.

16. The apparatus of claim 13, in which the means for oscillation detection comprises phase locked loop circuitry.

17. The apparatus of claim 13, in which the means for oscillation detection comprises means for detection of a large sustained amplitude in a particular frequency band.

18. The apparatus of claim 13, including including means for dividing the signal into a series of successive time windows, and means for applying to the signal, for each successive time window, a newly generated random or pseudo-random phase, and means for generating a complex number with random or pseudo-random phase and amplitude 1.0 for each successive time window, and means for applying this complex number to the signal in that frequency band.

19. The apparatus of claim 18, including means for multiplying a real gain value for said frequency band by said complex number before applying the gain to the signal.

20. The apparatus of claim 13, including including means for dividing the signal into a series of successive time windows, and means for applying to the signal, for each successive time window, a newly generated random or pseudo-random phase, and means for, for a particular frequency band and in each successive time window, replacing the signal or signal gain with a signal or signal gain having a random or pseudo-random phase.
